(19) United States
(12) Patent Application Publication
(10) Pub. No.: US 2012/0297177 A1
(43) Pub. Date: Nov. 22, 2012

(54) Hardware Assisted Operating System Switch

(76) Inventors: Anup K. Ghosh, Centerville, VA (US); Kun Sun, Fairfax, VA (US); Jiang Wang, Fairfax, VA (US); Angelos Stavrou, Springfield, VA (US)

(21) Appl. No.: 13/296,303

(22) Filed: Nov. 15, 2011

Related U.S. Application Data
(60) Provisional application No. 61/413,666, filed on Nov. 15, 2010.

(51) Int. Cl. G06F 15/177

(52) U.S. Cl. 713/2

(57) ABSTRACT

An interoperable firmware memory containing a Basic Input Output System (BIOS) and a trusted platform module (TPSM). The BIOS includes CPU System Management Mode (SMM) firmware configured as read-only at boot. The SMM firmware configured to control switching subsequent to boot between at least: a first memory and second isolated memory; and a first and second isolated non-volatile storage device. The first memory including a first operating system and the second memory including a second operating system. The first non-volatile storage device configured to be used by the first operating system and the second non-volatile storage device configured to be used by the second operating system. The trusted platform module (TPSM) configured to check the integrity of the CPU system Management Mode (SMM) during the boot process.

### CROSS-REFERENCE TO RELATED APPLICATIONS

This application claims the benefit of U.S. Provisional Application No. 61/413,666, filed Nov. 15, 2010, entitled “Enforcing Hardware-Assisted Integrity and Trust for Commodity Operating Systems,” which is hereby incorporated by reference in its entirety.

### STATEMENT REGARDING FEDERALLY SPONSORED RESEARCH OR DEVELOPMENT

This invention was made with government support under SBIR OSD10-1A4 funded by the Office of the Secretary of Defense. The government has certain rights in the invention.

### BACKGROUND

In recent years, there has been an increased reliance on personal computers for everyday activities. Services including banking, news, email communication, business arrangements may be accomplished from the comfort of one's home. To accommodate this usability and convenience operating systems and applications have increased both in size and complexity. However, computers now handle sensitive information such as financial information (e.g., bank account, credit card account, utility bills) or medical information. A trusted operating system is the first building block in order to further protect valuable information from being leaked out and misused by adversaries. Therefore, there is a need to ensure the integrity and trust for software stack(s) including underlying operating system(s).

### BRIEF DESCRIPTION OF THE SEVERAL VIEWS OF THE DRAWINGS

FIG. 1 is an architecture diagram of a secure switching system as per an aspect of an embodiment of the present invention.

FIG. 2 is a diagram showing interactions between components in a secure switching system as per an aspect of an embodiment of the present invention.

FIG. 3 is a flow diagram showing initialization and switching of two operating systems as per an aspect of an embodiment of the present invention.

FIG. 4 is an architecture diagram of a tamper-resistant monitoring mechanism as per an aspect of an embodiment of the present invention.

FIG. 5 is a block diagram of an aspect of an embodiment of the present invention.

FIG. 6 is a flow diagram of a switching mechanism as per an aspect of an embodiment of the present invention.

### DETAILED DESCRIPTION OF EMBODIMENTS

Embodiments of the present invention employ a secure hardware-assisted switching system that allows users to switch between operating systems on the same machine with a short switching time. In some embodiments, at least one of the operating systems may be a trusted operating system. In addition, some embodiments of the present invention may check the integrity of operating system(s). Embodiments may operate at the Basic Input Output System (BIOS) level to provide a thorough isolation between the Operating systems without sharing code (i.e. hypervisor or Virtual Machine Monitor code) that may compromise the integrity of operating systems. Some embodiments may remove avenues for a vulnerable or compromised untrusted operating system to compromise a trusted operating system or its applications even though the two systems may be installed and run on the same machine.

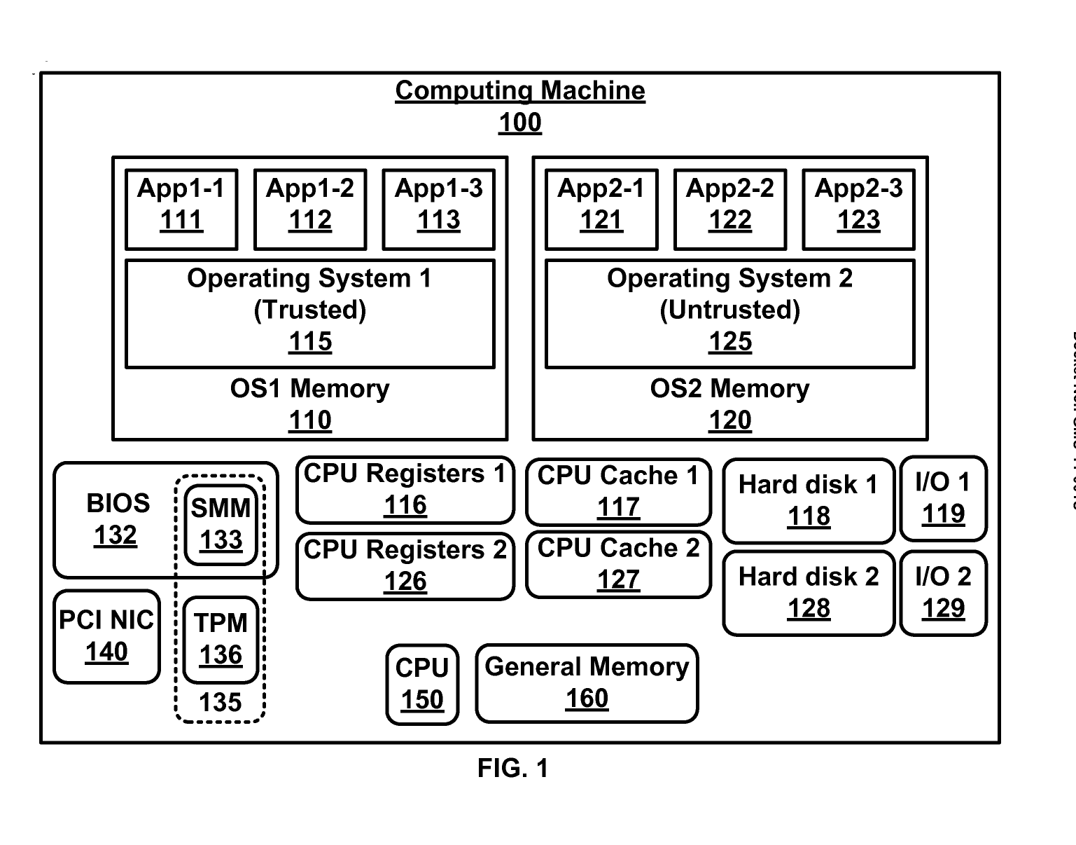

FIG. 1 illustrates an example architecture 100 of a secure switching system as per an aspect of an embodiment of the present invention. In this example, two operating systems 115 and 125 may be loaded into the computer memory 110 and 120 at the same time. A CPU System Management Mode (SMM) 133, which may be present in x86 commodity systems, may be employed to control switching between operating systems 115 and 125. A Trusted Platform Module (TPM) 136 may be employed during boot-up to ensure the integrity of the SMM 133. Therefore, reliance on the TPM 136 after the system boot-up process is complete may be removed. According to some embodiments, the combination of SMM 133 and TPM 136 may provide a Trusted Computing Base (TCB) 135 of the system. Because there is no running hypervisor or other software to connect the two operating systems in some embodiments, the attack surface may be smaller than hypervisor-based systems. An adversary may be limited to targeting the BIOS-anchored SMM 133 code, which may be tiny and without any need for foreign code (i.e. device drivers). Moreover, the BIOS 132 code may be set to read-only at boot-up using TPM 136 and thus protected from being modified by adversaries. The SMM 133 code and SMRAM may be locked once loaded at boot time preventing modification thereafter. Because embodiments maintain multiple operating systems 115 and 125 in the memory at the same time, but in separated memory address space 110 and 120, the switch time between the two operating systems 115 and 125 may be relatively short (few seconds). This may be much faster than switching between two operating systems on a multi-boot system on a computer.

Some embodiments of the present invention may use hardware-assisted isolation to prevent a compromised untrusted operating system 125 from compromising the trusted operating system 115 that may reside in memory at the same time. Memory, CPU, hard disk and Input/output systems may be isolated. The example embodiments disclosed below refer to switching between two isolated environments, however, one skilled in the art will recognize that some embodiments of the present invention may switch between more than two isolated environments.

Memory isolation: According to some embodiments, two operating system images 115 and 125 may run in separate memory spaces 110 and 120. Either operating system 115 and 125 may be prevented from accessing the other operating system's memory space after boot-up. Therefore, a process running in one operating system may be prevented from accessing (read/write/execute) the memory allocated to another operating system. To prevent data exfiltration attacks that may compromise the integrity of the BIOS 132 and read memory, in some embodiments the trusted operating system memory may be encrypted when it is switched out to add another layer of protection on the trusted operating system.

CPU isolation: In some embodiments, the operating systems (115 and 125) may be prevented from running concurrently. When one operating system (115 or 125 respectively) is switched off, content in registers (116 or 126 respectively) and CPU caches (117 or 127 respectively) may be saved in the operating system's memory (110 and 120 respectively) and flushed to prevent a hidden channel between the two operating systems (115 and 125) through the CPU 150, register memory (116 or 126), or caches (117 or 127).

Hard Disk isolation: According to some embodiments, each operating system (115 and 125 respectively) may have dedicated hard disk(s) (118 and 128 respectively) that other operating system are prevented from accessing. Installing separate hard disks, one for each operating system (115 and 125 respectively) may make hard disk isolation simpler. However, one skilled in the art will recognize that other methods of hard disk isolation may be implemented such as a hardware disk controller that provides separate access to different parts of a hard drive. Additionally, the hard drive may be implemented using multiple technologies such as memory storage devices, magnetic storage devices and optical storage devices. According to some embodiments, the whole disk for the trusted operating system may be encrypted to add another layer of protection.

I/O isolation: According to some embodiments, when one operating system (115 and 125) is switched off, content maintained by device driver(s) may be saved and then wiped out. At any time, at most one operating system (115 or 125) may have control of shared device(s) (119 or 129 respectively) to prevent hidden channel(s) between operating systems (115 and 125) through input/output devices (119 or 129).

Initially, the trusted operating system 115 may need to be secure and trusted. However, an operating system may contain tens of thousands of lines of code that may contain vulnerabilities that may be misused by attackers. If normal users may use the trusted operating system 115 for a long time, steps may be taken to protect the system from external attackers compromising the trusted operating system 115. To that end, a hardware-assisted integrity monitor may be employed to protect the trusted operating system 115 from attack(s). When a trusted operating system 115 is initialized, a hardware-assisted integrity monitor may harnesses the CPU System Manage Mode (SMM 133) to create a snapshot view of a pristine state of CPU 150 and memory registers (116) of the trusted operating system 115, and save it in TPM 136. During running time of the trusted operating system 115, the hardware-assisted integrity monitor may periodically call the SMM 133 to create a snapshot view of the current state of the CPU 150 and memory registers 116 of the trusted operating system 115. This information may be used to identify tampering by comparing the newly generated view with the one recorded in the TPM 136 when the trusted operating system 115 was initialized.

Combining secure switching with a hardware-assisted integrity monitor, embodiments of the present invention may secure the switching process between a trusted operating system 115 and untrusted operating system 125 as well as detect potential tampering of the trusted operating system 115.

System Design and Implementation

Threat Model

Some embodiments of the present invention may assume an adversary may subvert an operating system using any known or zero-day attacks. This may include applications, drivers, or user-installed code running on the machine. Furthermore, some embodiments of the present invention may assume the SMM 133 and TPM 136 are trusted and may not be compromised by attackers remotely. An attacker may launch simple physical attacks, such as opening the case or removing a hard disk. However, the attacker may be unable to launch sophisticated attacks like monitoring the bus that links the CPU and memory while the machine is in operation.

Trusted operating systems and associated applications may be installed on encrypted drive(s). Untrusted operating systems and associated applications may be installed on other drive(s). Some embodiments of the present invention may be configured such that each operating system may only access the drive allocated for it. In other words, the untrusted operating system may not read the trusted operating system drive.

Because some embodiments may not require hardware virtualization support (e.g, Intel VT-x or AMD-V), multiple operating systems may be accommodated in memory at the same time on some legacy systems without hardware virtualization support.

System Architecture

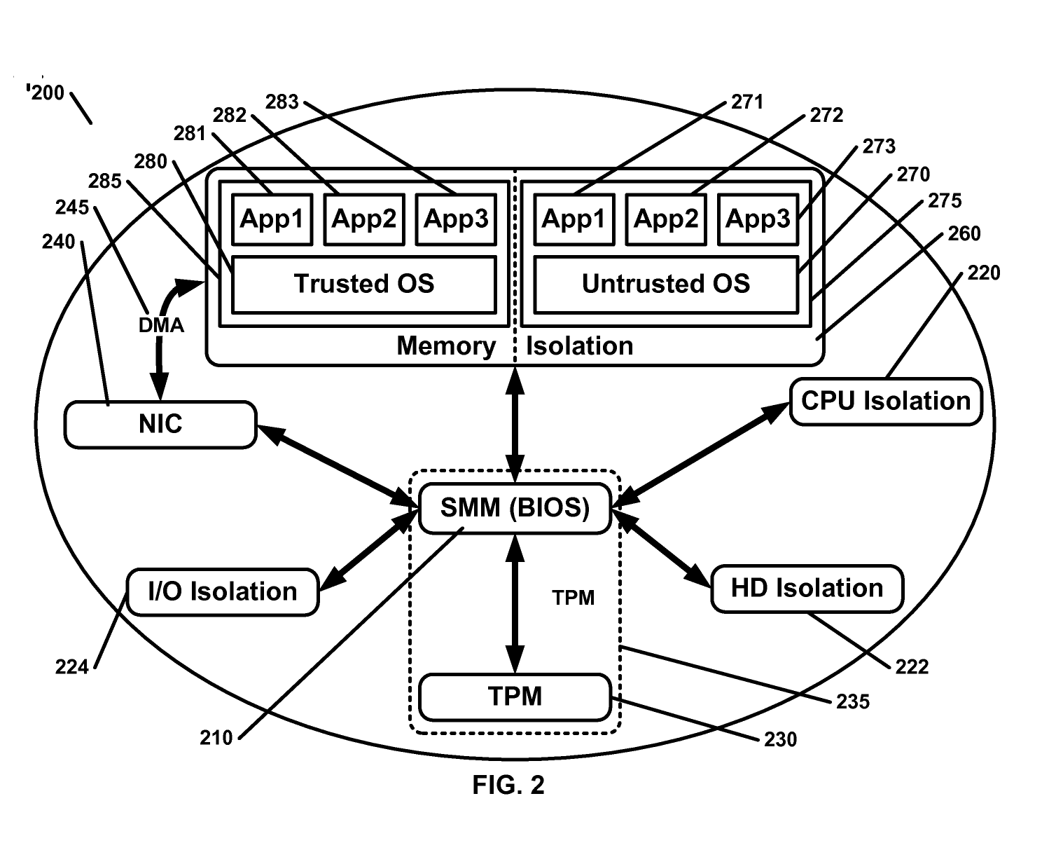

FIG. 2 shows the interactions between components in some of the secure switching system (200) embodiments. Some embodiments may not include a hypervisor. Both trusted and untrusted operating systems run like the traditional operating systems. When one operating system is running, it may not know of the existence of another operating systems collocated in the memory.

A CPU System Management Mode (SMM 210), such as is present in some x86 commodity systems, may be used to control the switching between operating systems (270 and 280). Embodiments may use a Trusted Platform Module (TPM 230) to protect the integrity of the SMM 210. SMM 210 and TPM 230 together may provide the Trusted Computing Base (TCB 235) of some embodiments.

System Management Mode (SMM 210) may be responsible for providing the isolation between at least a trusted operating system (280) and an untrusted operating system (270). SMM 210 may be a separate CPU mode besides the protected and real mode. An original purpose of SMM 210 provided a transparent mechanism for implementing platform specific functions such as power management and system security. Typically, a processor enters SMM 210 when the external SMM interrupt pin (SMI#) is activated or an SMI is received from an advanced programmable interrupt controller (APIC).

In SMM 210, the processor switches to a separate address space, called system management RAM (SMRAM). In addition, the hardware context of the currently running code may be saved in SMRAM. The CPU, being in SMM 210, may execute transparently, code that is usually a part of BIOS and resides in SMRAM. The SMRAM may be made inaccessible from other CPU operating modes. Therefore, SMRAM may act as trusted storage, sealed from being accessed from device(s) or even the CPU (while not in SMM mode). According to some embodiments, the SMM 210 code may be modified or otherwise configured to execute isolating and monitoring functions. This modification of SMM 210 code may be integrated into the BIOS.

Many commodity computers are equipped with a Trusted Platform Module (TPM 230). The TPM 230 may include a dedicated security chip designed to help establish trust in a computing platform. The TPM 230 may be thought of as possessing a public-private key pair, with the property that the private key be handled within a secure environment inside the TPM 230. According to some embodiments, the TPM 230 may contain Platform Configuration Registers (PCRs) that may be used to record the state of software executing on the platform. The PCRs may be append-only. Some embodiments may use PCR to record the pristine state of the trusted operating system 280. The Trusted Platform Module (TPM 230) is both the name of a published specification detailing a secure cryptoprocessor that may store cryptographic keys that protect information, as well as the general name of implementations of that specification, often called the “TPM chip” or “TPM Security Device”. The TPM specification is the work of the Trusted Computing Group, Incorporated of Beaverton, Oreg. This specification is also available as the international standard ISO/IEC 11889.

According to some embodiments, the TPM 230 may generate an attestation to verify the code integrity in BIOS and SMM 210 during boot time. An attestation is a signature with the TPM's 230 private key over the values currently held in the PCRs. Given the TPM's 230 corresponding public key, BIOS may check that the signature is valid and conclude that the PCR values in the attestation represent the software state of the BIOS.

Secure Switching

According to some example embodiments, there may be multiple processes to achieve secure switching. As illustrated in this embodiment, a Network Interface Controller (NIC 240 may be used to employ Direct Memory Access (DMA 245) to memory 260. Memory 260 may be separated into portions 285 and 275. Memory portion 285 may be configured to hold images of memory operating system 280 as well as associated applications 281, 282, . . . 283. Memory portion 275 may be configured to hold images of memory operating system 270 as well as associated applications 271, 272, . . . 273. Several isolation mechanisms may be employed to to prevent communications between operating system 280 and 270 such as: I/O isolation mechanism 224, CPU isolation mechanisms 220, and hard disk isolation mechanism 222.

One process may separate the physical memory 260 of the two operating systems into separate memory portions (285 and 275 respectively) so that there is minimum overlap. Another process may load the memory image of the second operating system 270 after the first operating system 280 has been loaded. Another process may switch between the two operating systems (270 and 280 respectively).

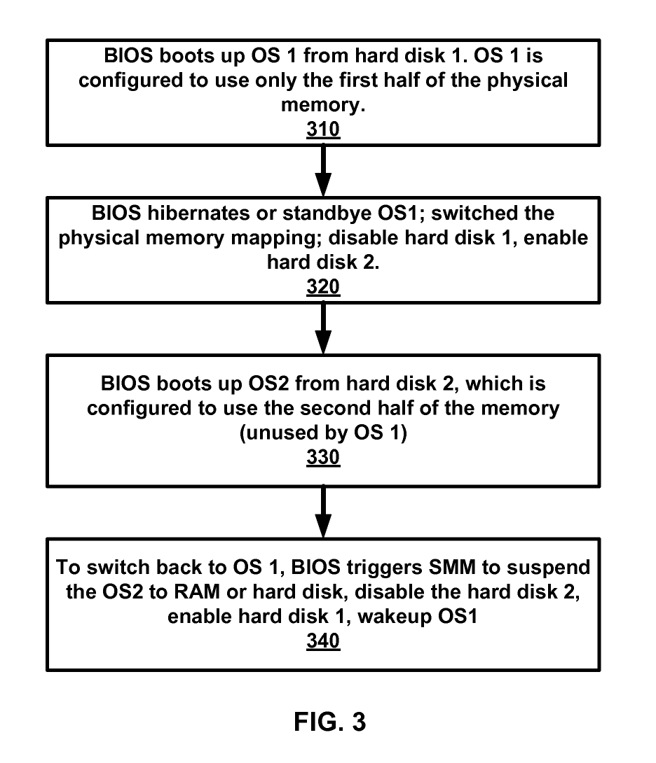

FIG. 3 shows a flow chart for initializing and switching two operating systems in a system according to an aspect of an example embodiment of the present invention. At 310, a user boots up operating system 1 (OS1) from hard disk 1. In this process, due to the secure control of some embodiments in BIOS, OS1 may be constrained to use only the first half of the physical memory and may not see the second half of the physical memory. Before BIOS boots up the second operating system (OS2), at 320 example embodiments may either hibernate OS1 and save context CPU registers in hard disk 1, or standby operating systems 1 and save context CPU registers in dedicated memory space. BIOS may switch the physical memory mapping (using the second half of the physical memory), disable hard disk 1 for OS1, and enable hard disk 2 for operating systems 2. At 330, BIOS may boot up operating systems 2 from hard disk 2 into the second half of the physical memory, which may have no overlapping with the memory used by OS1. By now, two operating systems may be loaded into the memory at the same time, and operating systems 2 is active and operating systems 1 is either hibernated or standby. If a user wants to switch back to OS1, BIOS may trigger SMM to suspend operating systems 2 and wakeup OS1 (340).

There may be no special requirement on the sequence of loading the trusted and untrusted Operating systems. Two options for switching the trusted OS include a stateless mode and a stateful mode.

Stateless mode: When a user switches into the trusted operating system, the trusted operating system starts from a pristine state. The system may not save the state when the trusted operating system is switched off. Some embodiments may revert the trusted operating systems to the previous state either from the hard disk or a reserved memory area.

Stateful mode: The state of the trusted operating system may be kept in memory. When the trusted operating system is switched back, the trusted operating system may be restored to the state when it was last switched off.

Isolation Between Trusted and Untrusted Operating Systems

According to some embodiments, the operating systems switching process may be controlled by BIOS, to ensure a thorough isolation between the trusted and untrusted Operating systems.

CPU Isolation

One implementation challenge may be to switch CPU from OS1 to OS2. When one operating system is switched out, embodiments may save the current CPU state of the operating system. The CPU state, including caches and registers, may be wiped out all before switching to another operating system.

CPU's, for example x86 CPU's, may have two caches on die: L1d for data; and L1i for instructions. Some modern PCs may also contain other higher-level caches, such as L2 or L3 cache. Another special cache is TLB used for paging. When switching from OS1 to OS2, some embodiments may make sure the cache is flushed back to the main memory. This may be done by setting the cache to be write-through. Another option is to use the S3 sleep (sometimes called suspend to RAM) to make sure the CPU and caches are in a predefined state. If this predefined state is similar to the initialization state, (i.e. there may be no exclusive states (CPU registers etc.) for each operating system), then the switching may not need to do any extra work to keep the CPU states. Otherwise, the BIOS or some other software may be needed to save the CPU states so that the CPU states may be restored after switching back.

According to some embodiments, the CPU System Management Mode (SMM) may be employed to obtain a snapshot view of the current state of the CPU and associated registers. When CPU switches to SMM, the SMM may save the register context in the SMRAM. According to an example embodiment, the default SMRAM size may be 640K Bytes beginning at a base physical address in physical memory called SMBASE. The SMBASE default value following a hardware reset may be 0×30000. The processor may look for the first instruction of the SMI handler at the address [SMBASE+0×8000]. SSM may store the processor's state in the area from [SMBASE+0xFE00] to [SMBASE+0xFFFF]. That means embodiments may get the operating systems states (which is in CPU protected mode) after being switched to SMM. Therefore, the integrity of the trusted operating systems in SMM may be checked.

Memory Isolation

It may be a challenging task to provide two non-overlapping memory spaces for two operating systems and constrain the memory access privilege of each operating system without using a hypervisor or VMM. According to some embodiments, a boot loader or operating system may use int15 e820 to detect memory size. The physical memory may be divided to two parts: low memory (0-640K) and normal memory (>640K). Low memory may have special meanings and therefore may not be changed. Other embodiments may expand on this scheme to map additional memory partitions and to map memory partitions of different sizes.

Some embodiments of the present invention may configure the BIOS to report only half of the memory to each operating system and ensure the two operating systems use the different parts of the main memory. An example embodiment using the AMD K8 microprocessor will now be described. More specifically, AMD K8 may include a memory controller in the K8 CPU (memory controller is previously on the North Bridge). Accordingly, it may provide two registers: BaseAddrReg and BaseMaskReg to set the memory address for the memory modules. These registers may be used by BIOS to configure the physical address range of each memory module. In an example prototype embodiment, two identical memory modules may be installed on the main board. For example, each one may be a 1 GB size DDR2 memory module. The BIOS may be modified so that when the system boots the first OS, module 1 is assigned the physical address from 0 to 1 GB and the module 2 is from 1 GB to 2 GB. The operating system 1 may be configured to use the only first 1 GB of the memory. That means the second half of the memory is unused by the operating system 1.

According to some embodiments, when switching from OS1 to OS2, the BIOS may be modified and the memory reconfigured so that memory module 1 has the address from 1 GB to 2 GB while memory module 2 is from 0 GB to 1 GB. Again, OS2 may be configured to use only the first half of the memory. By doing so, the two operating systems may be physically separated in two different memory modules. According to some embodiments, the trusted OS may be encrypted to prevent the untrusted operating system from tampering with the trusted operating system.

Hard Disk Isolation

According to some embodiments, two hard disks may be installed in a system. Each operating system may have its own hard disk. For the trusted OS, the whole hard disk may be encrypted. The BIOS may be configured to ensure that each operating system may only access its own hard disk by only enabling the hard disk for the operating system when it is switched in, while disabling the hard disk for the switched-off OS.

I/O Device (NIC, Key Board, Mouse, Monitor) Isolation

According to some embodiments, when one operating system is running, it may have control over hardware devices such as the NIC, Keyboard, mouse, monitor, etc. Before one operating system is switched out, the BIOS may save a snapshot of the memory buffer of the device and then wipe out the buffer. The BIOS may then load in the snapshot of the switch-in operating system for the devices.

Tamper-Resistant Monitoring

When users utilize the trusted operating system for relatively long hours (such as for regular work each day), some embodiments of the present invention may protect the trusted operating systems after it is securely loaded into the memory. The trusted operating system may still contain applications that exhibit zero-day vulnerabilities that may be attacked from remote computers. To address that, some embodiments may employ a tamper-resistant monitoring mechanism such as a hardware-assisted integrity monitor to monitor the memory and registers of trusted operating systems for potential attacks. If the hardware-assisted integrity monitor detects a malicious changing of the operating system, the monitor may notify the user and/or take actions to shutdown the compromised operating system.

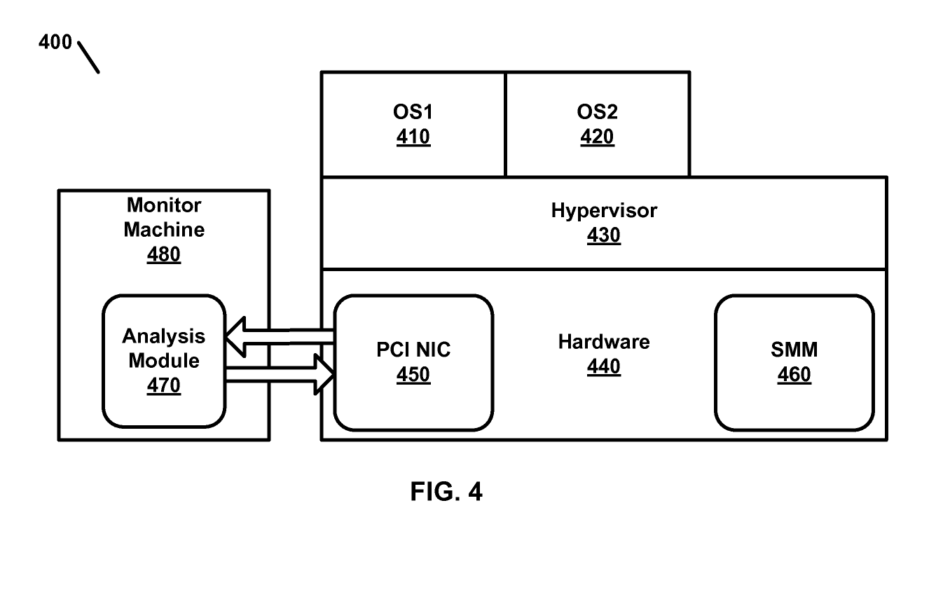

A block diagram of an example embodiment of a hardware-assisted integrity monitor system 400 is depicted in FIG. 4. This example embodiment of a hardware-assisted integrity monitor 400 may leverage the CPU System Managed Mode (SMM) 460 to securely generate and transmit the state of the protected machine to an external server 480. The remote monitor machine 480 may run an analysis module 470 that enables the creation of an “out-of-box” state of the running software in the target machine 440. If an attacker attempts to tamper with the state of the target machine 440, the remote machine 470 may be notified and the operations in the machine 440 may be terminated. This service may run on a central server that receives feed from many desktop machines or may run on a dedicated monitor machine. Embodiments of hardware-assisted integrity monitors 400 may not prevent an adversary from tampering with the machine 440, but the embodiments may quickly detect the tampering and suspend activities preventing the attacker from extracting information from the victim. An attacker may attempt to prevent the SMM 460 from being triggered but this action may also be detected via a periodic update of the remote monitoring machine 470 with the state of the target system 440. Using an embodiment of a hardware-assisted integrity monitor 400 may successfully ferret out rootkits that target the integrity of both hypervisors 430 and traditional Operating systems 410 and 420. Moreover, embodiments of hardware-assisted integrity monitors 400 may be robust against attacks that aim to disable or block operations. A prototype embodiment produced and communicated a scan of the state of the protected software in less than few milliseconds depending on the number of monitored programs.

Security

Embodiments of the present invention may be built to not share code between the untrusted and trusted operating systems beyond BIOS and the SMM extensions. This approach is a departure from current hypervisor and virtualization research and may be used as a complementary approach to existing hypervisor and operating systems protection architectures.

By not sharing state(s) between operating systems, hardware devices including CPU, CPU registers, CPU caches, communication devices, volatile and non-volatile memory, storage (disks) may be isolated and any state that results from the use of each system wiped out.

Embodiments of a hardware-assisted monitor and/or a hardware-assisted integrity monitor may be leveraged to ensure the trustworthiness of the trusted operating systems and applications while they are operational for an extended period of time. Again, embodiments of the present invention may be used to complement existing approaches that attempt to guarantee the integrity of the hypervisors because it runs one level lower (i.e. it is hardware-based).

Unlike approaches that require rebooting or the use of a second machine, embodiments of the present system may use commodity equipment to load two isolated operating systems and achieve quick switching between the two operating systems.

Some embodiments may have a few limitations such as preventing an attacker from creating a Denial of Service either by preventing the system from entering the SMM mode or by bypassing the BIOS and writing data to the trusted operating system. However, some embodiments may be able to detect such attacks thus preventing the attacker from exfiltrating information or causing further damage. Another possible limitation of some embodiments includes protecting the system against physical attacks that can monitor the system while in operation. However, embodiments may protect against attacks that involve removal of storage or of memory.

Embodiments of the present invention may solve the challenge of running two operating systems side by side. Most current operating systems are designed to run solely on hardware. The nature of many operating systems is to control all the hardware and provide services to the applications. Therefore, one may not just install two operating systems and hope they will run side-by-side. One solution is to install two operating systems as a dual boot system, hibernating one of them and then wakeup another one for switching. This method may provide isolation between two operating systems. However, this method may involve a long time for hibernation, because hibernating requires writing the whole main memory content to the hard disk. Also, this method may require rebooting the machine, which may also take several seconds to tens of seconds depending on the hardware. The reboot delay may be optimized to 2-5 sec for a special BIOS, but the delay for reading the memory content to and from the hard disk may not be avoidable.

Some embodiments of the present invention may accommodate two operating systems into the memory at the same time, therefore, saving the time of saving current operating systems memory image to hard disk and reading the second operating systems from hard disk to memory.

Another possible solution is to use virtual machine monitor or a hypervisor to add an extra layer between the Operating systems and the real hardware. In HyperSpace, if a hypervisor is trusted, then this method may also provide isolation between two operating systems. Nevertheless, attacks to the hypervisors are more and more frequent. Because the hypervisor is responsible for controlling the device drive, memory, CPU, etc., it may not avoid the frequent switching between the hypervisor and the VMs. Although the hypervisor may have a smaller attack surface compared to traditional operating systems, the hypervisor may still be vulnerable to attacks. Once the hypervisor is compromised, all the operating systems, including the trusted operating system may also be compromised.

A third potential solution may be to modify the operating systems itself so that two operating systems run side-by-side. However, memory management is a complicated component in an operating system and is therefore difficult to modify the operating systems to not use the low memory (physical memory below 10 MB). This is one of motivations for the para-virtualization technologies to add an extra-layer of memory management instead of modifying the original operating systems design.

Embodiments of the present invention may configure the BIOS to give an operating system the same hardware view as before but also give two operating systems two different views of the hardware (especially the memory). Some embodiments may reconfigure the BIOS. Some BIOS are private software and some are open source BIOS (such as coreboot). Coreboot is a Free Software project aimed at replacing the proprietary BIOS (firmware) that was initially funded by the Los Alamos Computer Science Institute and the Department of Energy's Office of Science. After reconfiguring the BIOS, the operating systems may remain the same. Moreover, reconfiguring the BIOS may support operating systems available for hardware without modification. Hypervisor-based methods may need to constantly running in the main memory and could be attacked. According to some embodiments, the BIOS and the SMM part may only run during booting and switching. The code for SMM may reside in SMRAM that may be locked to prevent operating systems (or hypervisor) from accessing it. A TPM may ensure the BIOS integrity when it is not loaded into the memory.

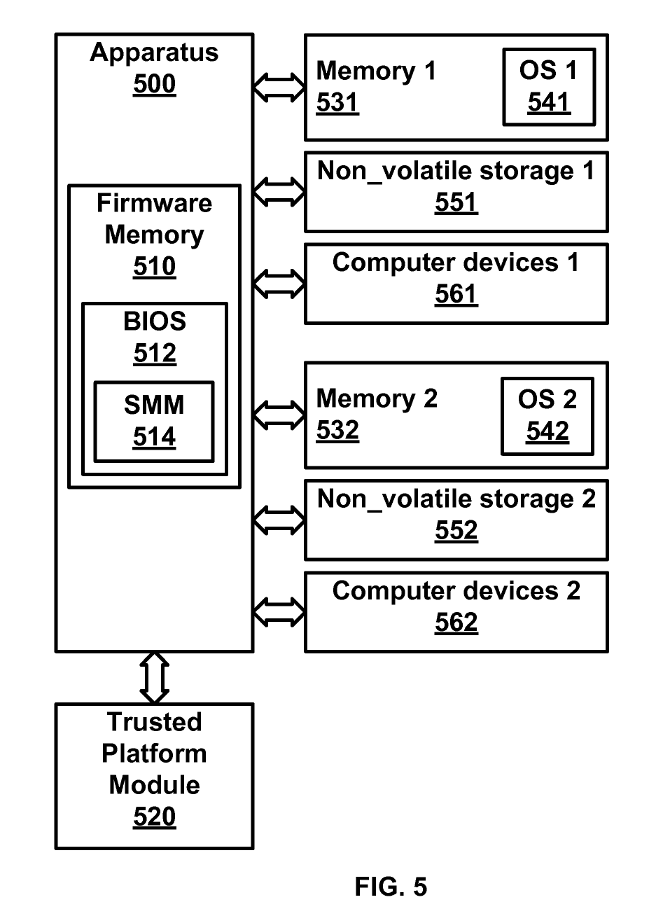

Referring to FIG. 5, according to some embodiments, an apparatus 500 may include a firmware memory 510 and a trusted platform module (TPSM) 520. The firmware memory 510 may contain a BIOS firmware 512 and SMM firmware 514. Some embodiments may be configured to prevent a first operating system 541 and a second operating system 542 from running concurrently by switching between isolated hardware elements. Examples of isolated hardware elements include, but are not limited to, non-volatile storage 1 (551) and non-volatile storage 2 (552).

The BIOS 512 may include CPU System Management Mode (SMM) firmware 514 configured to control switching subsequent to a boot process. A boot process (also known as booting or booting up) includes the initial set of operations that a computer performs when power is switched on. A boot process may configure computer hardware and load an operating system on a computer. In some embodiments, the boot process may be extended to enable secure switching.

According to some embodiments, the firmware memory 510 may be configured to be read-only at the boot process. For example, in one embodiment, the firmware memory 510 may be a full-time read only memory. In another embodiment, the firmware memory 510 may be a read/write memory that is locked in a read-only configuration at boot. The lock may be implemented using a hardware locking mechanism such as electrically disconnecting a write signal from the firmware memory.

According to some embodiments, the CPU System Management Mode (SMM) firmware 514 may be configured to control switching between a first memory 531 and a second memory 532. The first memory 531 may be configured to hold an image of a first operating system 541. The second memory 532 may be configured to hold an image of a second operating system 542. The first memory 531 may be isolated from the second memory 532.

According to some embodiments, the CPU System Management Mode (SMM) firmware 514 may be configured to control switching between a first non-volatile storage device 551 and a second non-volatile storage device 552. The first non-volatile storage device 551 may be configured to be used by the first operating system 541. The second non-volatile storage device 552 may be configured to be used by the second operating system 542. The first non-volatile storage device 551 may be isolated from the second non-volatile storage device 552.

Non-volatile storage may be a storage configured to retain stored information even when not powered. Examples of non-volatile storage include, but are not limited to, read-only memory, flash memory, ferroelectric RAM, most types of magnetic computer storage devices (e.g. hard disks, floppy disks, and magnetic tape), optical discs, and early computer storage methods such as paper tape and punched cards. For example, according to some embodiments, the first non-volatile storage device 551 may be a first hard disk while the second non-volatile storage device 552 may be a second hard disk.

According to some embodiments, security may be enhanced by encrypting data on device(s). For example, the first non-volatile storage devices 551 and/or second non-volatile storage devices 552 may be configured to store encrypted data. As another example, the first memory 531 and/or second memory 532 may be configured to store encrypted data.

According to some embodiments, the CPU System Management Mode (SMM) firmware 514 may be configured to control switching between first computer devices 561 and second computer devices 562. First computer devices 561 and second computer devices 562 may each include devices such as, but not limited to: CPU register(s); CPU cache(s); communications device(s); device driver(s); or the like. The switching may also be between combinations of devices.

According to some embodiments, the CPU System Management Mode (SMM) firmware 514 may be configured to flush at least one device during a switching operation. Flushing a device may include cleaning or emptying a device. In some embodiments, flushing may include copying data from a temporary storage area such as RAM to a more permanent storage medium such as a disk. In some embodiments, flushing may include preparing a device for use. Examples of devices that may be flushed include, but are not limited to: CPU register(s); CPU cache(s); communications buffer(s); hard disk(s); memory; device driver(s); or the like. Flushing may be performed on combinations of devices. For example, the switching subsequent to a boot process may include the contents of at least one CPU register being saved in a memory and the contents of the at least one CPU resister being flushed. In another example, the switching subsequent to a boot process may include the contents of at least one CPU cache being saved in a memory and the contents of the at least one CPU cache being flushed. In yet another example, the switching subsequent to a boot process may include the contents of at least one device driver being saved in a memory and the contents of the at least one device driver being flushed.

According to some embodiments, the switching subsequent to a boot process may include: the first operating system 541 employing the first memory 531 and the first operating system 541 being isolated from the second memory 532; and the second operating system 542 employing the second memory 532 and the second operating system 542 being isolated from the first memory 531. To achieve this, some embodiments may physically isolate the first memory 531 from the second memory 532 and switch in and out of operation the memory devices 531 and 532 such that both memory devices 531 and 532 are not operating at the same time. For example, the first memory 531 and the second memory 532 may be physically different modules. Some embodiments may increase isolation by mapping the first memory 531 to a different address range than the second memory 532.

According to some embodiments, the switching subsequent to a boot process may include one of the following: the first operating system 541 employing the first non-volatile storage device 551 and the first operating system 541 being isolated from the second non-volatile storage device 552; and the second operating system 542 employing the second non-volatile storage device 552 and the second operating system 542 being isolated from the first non-volatile storage device 551.

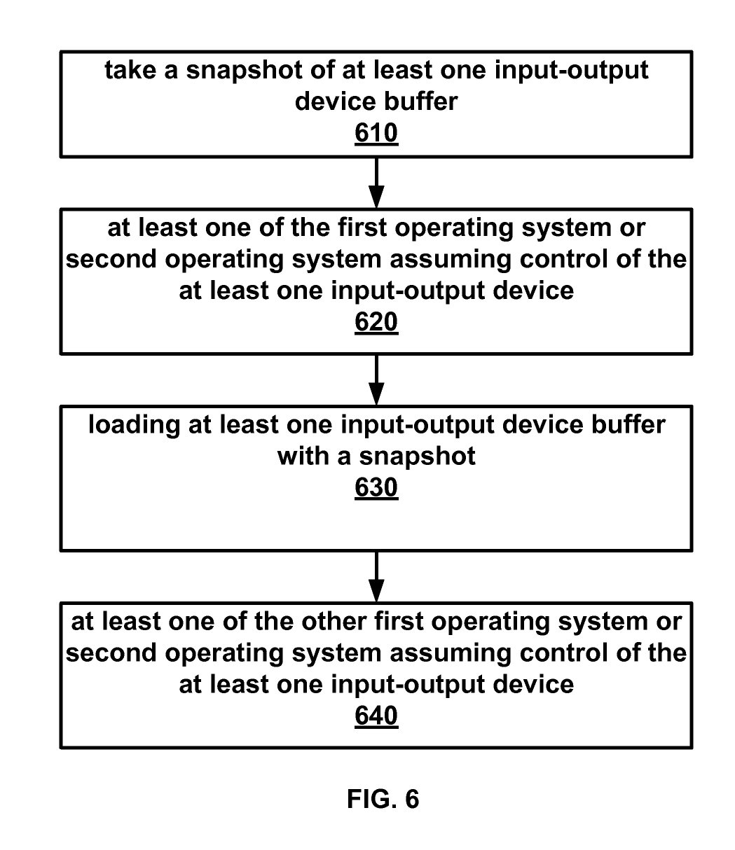

FIG. 6 is a flow diagram of an aspect of an embodiment of the present invention switching subsequent to a boot process. At 610 a snapshot may be taken of at least one input-output device buffer. At least one of the first operating system or second operating system may assume control of the at least one input-output device at 620. The at least one input-output device buffer may be loaded with another snapshot at 630. At least one of the other first operating system or second operating system may assume control of the at least one input-output device at 640.

According to some embodiments, one operating system, such as OS1 541, may be provided unilateral access to devices 562 associated with the other operating system 542. As another example, the second operating system 542 may be configured to have access to the first non-volatile storage device 551. Additionally, in some embodiments, the second operating system 542 may be configured to have access to the first memory 531.

According to some embodiments, the BIOS function may be implemented by one or more processors executing a series of computer readable instructions that reside on a non-transitory tangible computer readable medium. The BIOS 512 may employ a CPU System Management Mode 514 configured to control switching subsequent to a boot process. The non-transitory computer readable medium may be configured to be read-only at the boot process. Additionally, the non-transitory computer readable medium may be configured to interface with a trusted platform module (TPSM) 520 that is configured to check the integrity of the CPU system Management Mode (SMM) 514 during the boot process.

The switching may include switching between a first memory 531 and a second memory 532 where the first memory 531 is configured to hold an image of a first operating system 541 and the second memory 532 is configured to hold an image of a second operating system 542. The first memory 531 may be isolated from the second memory 532. Similarly, the switching may include switching between a first non-volatile storage device 551 and a second non-volatile storage device 552 where the first non-volatile storage device 551 is configured to be used by the first operating system 541 and the second non-volatile storage device 552 is configured to be used by the second operating system 542. The first non-volatile storage device 551 may be isolated from the second non-volatile storage device 552.

According to some embodiments, the TPSM 520 may employ a tamper-resistant monitor to detect whether any data such as an operating system (541 or 542) has been modified. The tamper-resistant monitor may be hardware assisted. Additionally, the tamper-resistant monitor may employ a hypervisor.

Embodiments of the present invention include a first port 210, a second port 250 and a processor 230.

According to some embodiments, the first port 210 may be configured to communicatively connect to an on-board diagnostic system 215. The first port 210 may be configured to receive 0 DB data. The on-board diagnostic system 215 may be a vehicle on-board diagnostic system. Some on-board diagnostic systems

According to some embodiments, the second port 250 may be configured to communicatively connect to a monitor 255 that may be configured to communicatively connect to the on-board diagnostic system 215. The monitor 255 may be a vehicle monitor.

According to some embodiments, the processor 230 may be configured to send managed data to the second port 250, the managed data configured to appear as if it originates from the on-board diagnostic system 215. Processor 230 may include any number of devices that have a capability to perform at least some of the functions described in this disclosure. Examples of such devices include dedicated microcontroller(s), microprocessor(s), programmable hardware, computers, laptops or the like.

The managed data may be many types of data depending on the source of the data. In some embodiments, the managed data is managed vehicle data. At least some of the managed data may have been received at the first port. The processor 230 may be further configured to generate at least some of the managed data by modifying selected data received at the first port 210.

According to some embodiments, at least some of the managed data may be simulated. Simulated managed data may be simulated by the processor, or in some embodiments, be provided by some other source, such as an external computing machine. At least some of the simulated data may employ information determined through communications through the first port 210 at a previous time to a device such as on-board diagnostic system 215. At least some of the simulated data may employ driving characteristic data. Driving characteristic data may include data that describes how managed vehicle is expected to represent the behavior of the vehicle. Examples of driving characteristic data may include, but is not limited to, acceleration data, braking data, rpm data, speed data or the like.

At least some of the managed data may be modified speed data. Similarly, the managed data may be configured to make a vehicle employing an on-board diagnostic system to appear to be at least one of the following: turned off; driving slowly; accelerating slowly; decelerating slowly; a combination thereof or the like.

Communications between the on-board diagnostic system and port 1 may occur using any number of communication ports. Similarly, communications between the monitor and port 2 may occur using any number of communication ports. Examples of communication ports include, but are not limited to: OBD port(s); OBD II port(s); RS-232 port(s); USB port(s); RS-422 port(s); digital port(s); Ethernet port(s); bluetooth port(s); wireless ports or a combination of the above or the like.

Some embodiments may further include a signal conditioning circuit 220 between the first port 210 and the processor 230. Similarly, some embodiments may further include a signal conditioning circuit 240 between the second port 250 and the processor 230. The conditioning circuits 220 and 250 may adapt communication signals and/or protocols between differing standards. For example, processor 230 may with to communicate using a parallel digital signal while a port may be configured to communicate with a device that is configured to communicate using a serial communications signal. In this example, the conditioning circuit may convert the signals between the parallel and serial configurations. In another example, the processor and device may both communicate using a serial protocol, but at different electrical levels. In this case the signal conditioning circuit may convert those levels. In yet another example, the processor and device may both communicate using a serial protocol, but at different baud rates. In this case the signal conditioning circuit may convert the baud rate and provide synchronization signals.

Signal conditioning circuit(s) may be configured to selectively emulate a vehicle in an off state.

Some embodiments of the present invention may be configured with a third port that is configured to communicate with another device such as a terminal, a processor, configuration device, a user, a combination thereof or the like.

Some embodiments may further include a switch configured to switch the apparatus between different modes. The modes may include, but are not limited to: an off mode; a good driver mode; a normal mode; a pass through mode; a simulation mode; a combination thereof or the like. The switch could be a software/firmware switch or a hardware switch. In the case of a software/firmware switch, a command may be presented to processor 230 through one of the ports (210, 250 or 260). A hardware switch may include a switch that is configured to provide a logic level to processor 230.

Some embodiments of the present invention may be implemented as a method. For example, such a method may include one or more processes. One example process may include receiving data from an on-board diagnostic system. Another example process may include employing at least one processor to generate managed data configured to appear as if it originates from the on-board diagnostic system. Yet another example process may include sending the managed vehicle data to a monitor that is configured to connect to the on-board diagnostic system. These processes are only examples. It is envisioned that processes may be implemented to perform any or all of the techniques describer in this disclosure. Some embodiments of the present invention may be implemented as a non-transient computer readable media containing instructions configured to one or more processors to perform methods and/or processes such as those just described.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, punched cards and paper tapes, optical disks, barcodes, magnetic ink characters and/or the like.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of systems that switch between two isolated operating systems. However, one skilled in the art will recognize that embodiments of the invention could be used to isolate and switch between more than two isolated operating systems.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. An apparatus comprising:
a) a firmware memory containing a BIOS, the BIOS:
i) including CPU System Management Mode (SMM) firmware configured to control switching subsequent to a boot process, the switching including:
(1) switching between a first memory and a second memory, the first memory configured to hold an image of a first operating system, the second memory configured to hold an image of a second operating system, the first memory being isolated from the second memory; and
(2) switching between a first non-volatile storage device and a second non-volatile storage device, the first non-volatile storage device configured to be used by the first operating system, the second non-volatile storage device configured to be used by the second operating system, the first non-volatile storage device being isolated from the second non-volatile storage device; and
ii) configured to be read-only at the boot process; and
b) a trusted platform module (TPSM) configured to check the integrity of the CPU system Management Mode (SMM) during the boot process.

2. An apparatus according to claim 1, wherein the first non-volatile storage device is a first hard disk and the second non-volatile storage device is a second hard disk.

3. An apparatus according to claim 1, further including the CPU System Management Mode (SMM) firmware configured to control switching between at least one of the following:
a) a first CPU register and a second CPU register;
b) a first CPU cache and a second CPU cache;
c) a first communications device and a second communications device;
d) a first device driver and a second device driver; or
e) a combination of the above.

4. An apparatus according to claim 1, further including the CPU System Management Mode (SMM) firmware configured to flush at least one of the following during a switching operation:
a) a CPU register;
b) a CPU cache;
c) a communications buffer;
d) a hard disk;
e) a memory;
f) device driver; or
g) a combination of the above.

5. An apparatus according to claim 1, wherein at least one of the first non-volatile storage device or the second non-volatile storage device is encrypted.

6. An apparatus according to claim 1, wherein at least one of the first memory or the second memory is encrypted.

7. An apparatus according to claim 1, further including a tamper-resistant monitor.

8. An apparatus according to claim 7, wherein the tamper-resistant monitor is a hardware-assisted integrity monitor.

9. An apparatus according to claim 7, wherein the tamper-resistant monitor employs a hypervisor.

10. An apparatus according to claim 1, wherein the apparatus is configured to prevent the first operating system and the second operating system from running concurrently.

11. An apparatus according to claim 1, wherein the switching subsequent to a boot process includes:
a) the contents of at least one CPU register being saved in a memory; and
b) the contents of the at least one CPU resister being flushed.

12. An apparatus according to claim 1, wherein the switching subsequent to a boot process includes:
a) the contents of at least one CPU cache being saved in a memory; and
b) the contents of the at least one CPU cache being flushed.

13. An apparatus according to claim 1, wherein the switching subsequent to a boot process includes:
a) the contents of at least one device driver being saved in a memory; and
b) the contents of the at least one device driver being flushed.

14. An apparatus according to claim 1, wherein the first memory is physically distinct from the second memory.

15. An apparatus according to claim 1, wherein the first memory is mapped to a different address range than the second memory.

16. An apparatus according to claim 1, wherein the switching subsequent to a boot process includes one of the following:
a) the first operating system employing the first memory and the first operating system being isolated from the second memory; and
b) the second operating system employing the second memory and the second operating system being isolated from the first memory.

17. An apparatus according to claim 1, wherein the switching subsequent to a boot process includes one of the following:
a) the first operating system employing the first non-volatile storage device and the first operating system being isolated from the second non-volatile storage device; and
b) the second operating system employing the second non-volatile storage device and the second operating system being isolated from the first non-volatile storage device.

18. An apparatus according to claim 1, wherein the switching subsequent to a boot process includes:
a) taking a snapshot of at least one input-output device buffer;
b) at least one of the first operating system or second operating system assuming control of the at least one input-output device.
c) loading at least one input-output device buffer with a snapshot;
d) at least one of the other first operating system or second operating system assuming control of the at least one input-output device.

19. An apparatus according to claim 1, wherein the second operating system is configured to have access to the first non-volatile storage device.

20. An apparatus according to claim 1, wherein the second operating system is configured to have access to the first memory.

21. A non-transitory computer readable medium containing a series of computer readable instructions that when executed by one or more processors cause the one or more processors to perform Basic Input Output System function comprising a CPU System Management Mode (SMM) firmware configured to control switching subsequent to a boot process, the switching including:
a) switching between a first memory and a second memory, the first memory configured to hold an image of a first operating system, the second memory configured to hold an image of a second operating system, the first memory being isolated from the second memory; and
b) switching between a first non-volatile storage device and a second non-volatile storage device, the first non-volatile storage device configured to be used by the first operating system, the second non-volatile storage device configured to be used by the second operating system, the first non-volatile storage device being isolated from the second non-volatile storage device; and
wherein the non-transitory computer readable medium is configured to:
i) be read-only at the boot process; and
ii) to interface with a trusted platform module (TPSM) configured to check the integrity of the CPU system Management Mode (SMM) during the boot process.
